(19) United States
(12) Patent Application Publication
(10) Pub. No.: US 2017/0370239 A1
(43) Pub. Date: Dec. 28, 2017

(54) TURBINE SYSTEMS WITH SEALING COMPONENTS

(71) Applicant: General Electric Company, Schenectady, NY (US)

(72) Inventors: Venkat Subramaniam Venkataramani, Clifton Park, NY (US); Neelesh Nandkumar Sarawate, Niskayuna, NY (US); Anthony Christopher Marin, Saratoga Springs, NY (US); Wayne Charles Hasz, Pownal, VT (US); Stephen Francis Bancheri, Albany, NY (US); Edip Sevincer, Watervliet, NY (US)

(21) Appl. No.: 15/189,122

(22) Filed: Jun. 22, 2016

(51) Int. Cl. F01D 11/00; F01D 11/08; F01D 25/00

(52) U.S. Cl. CPC F01D 11/005; F01D 25/005; F01D 11/08; F05D 2300/5021; F05D 2240/55; F05D 2240/11; F05D 2300/6033; F05D 2300/609; F05D 2300/21

(57) ABSTRACT

A turbine system including a sealing component is presented. The sealing component includes a ceramic material. The ceramic material includes grains having an average grain size of less than 10 microns. A turbine shroud assembly including the sealing component is also presented.

Embodiments of the present disclosure generally relate to turbine systems, and particularly to sealing components between adjacent components of the turbine systems. Specifically, embodiments of the present disclosure relate to the sealing components having ceramic materials for improved thermal stability in the high temperature environments of the turbine systems.

### BACKGROUND

During operation of a turbine system such as a gas turbine system, air is pressurized in a compressor, mixed with fuel in a combustor, and ignited for generating hot combustion gases that flow downstream into a turbine so as to extract mechanical energy therefrom. Many components that form the combustor and turbine sections are directly exposed to the hot gases flow, for example, the combustor liner, transition duct between the combustor and the turbine, and turbine stationary vanes, rotating blades and surrounding shroud assemblies.

Overall efficiency and power of the turbine systems may be increased by increasing the firing temperature of the combustion gases. High efficiency turbine systems may have firing temperatures exceeding about 1600 degrees Celsius, and firing temperatures are expected to be higher than the current typically used firing temperatures as the demand for more efficient turbine systems continues. Ceramic matrix composite (“CMC”) materials may be potentially more suitable to withstand and operate at higher temperatures as compared to traditionally used metallic materials (for example, cobalt and nickel-based superalloys). Typical CMC materials incorporate ceramic fibers in a ceramic matrix for enhanced mechanical strength and ductility.

Although the use of CMC materials may reduce the cooling requirements in a turbine system, the overall efficiency of the turbine system may be improved by preventing the parasitic losses caused due to the leakage of the hot gases and the cooling medium, and mixing of the cooling medium with the hot gases. For example, sealing mechanisms such as spline seals may be used to seal the gaps between adjacent components of the turbine system to prevent such leakage and mixing. Current spline seals use many different combinations and configurations of metal shims and metal wire mesh. However, these metallic spline seals may not be suitable for use with CMC material components in the turbine systems at high temperatures, for example higher than 1000 degrees Celsius.

Therefore, there is a need for improved sealing components suitable for use in high temperature environments of turbine systems.

### BRIEF DESCRIPTION

Provided herein are improved seals for turbine systems. In one aspect provided herein is a turbine system comprising a sealing component that includes a ceramic material. The ceramic material includes grains having an average grain size of less than 10 microns.

In one aspect, a turbine shroud assembly comprises a plurality of shroud segments disposed adjacent to one another and a sealing component positioned between two adjacent shroud segments of the plurality of shroud segments. The sealing component comprises a ceramic material including grains having an average grain size of less than 10 microns.

These and other features, embodiments, and advantages of the present disclosure may be understood more readily by reference to the following detailed description.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of a turbine system, in accordance with one embodiment of the systems described herein;

FIG. 2 is a cross sectional schematic view of a portion of a turbine system, in accordance with one embodiment of the systems described herein;

FIG. 3 is a cross sectional schematic view of a portion of a turbine system, in accordance with another embodiment of the systems described herein;

FIG. 4 is a cross sectional schematic view of a portion of a turbine system, in accordance with yet another embodiment of the systems described herein; and

FIG. 5 is a cross sectional schematic view of a portion of a turbine shroud assembly, in accordance with one embodiment of the systems described herein.

### DETAILED DESCRIPTION

In the following specification and the claims, the singular forms “a”, “an” and “the” include plural referents unless the context clearly dictates otherwise. As used herein, the term “or” is not meant to be exclusive and refers to at least one of the referenced components being present and includes instances in which a combination of the referenced components may be present, unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, is not limited to the precise value specified. In some instances, the approximating language may correspond to the precision of an instrument for measuring the value.

Unless defined otherwise, technical and scientific terms used herein have the same meaning as is commonly understood by one of skill in the art to which this disclosure belongs. The terms “comprising,” “including,” and “having” are intended to be inclusive, and mean that there may be additional elements other than the listed elements. The terms “first”, “second”, and the like, as used herein do not denote any order, quantity, or importance, but rather are used to distinguish one element from another.

As used herein, the term “high operating temperature” or “high temperature” refers to an operating temperature that is higher than 1000 degrees Celsius, of a turbine system. In an alternate embodiment, high temperature refers to an operating temperature that is higher than 1200 degrees Celsius. In an further embodiment, high temperature refers to an operating temperature that is higher than 1400 degrees Celsius.

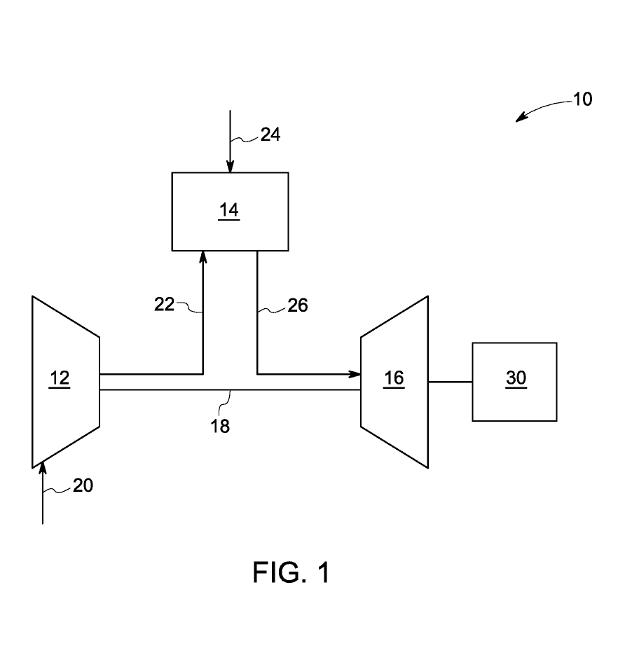

FIG. 1 is a schematic diagram of a turbine system 10, for example a gas turbine system. The turbine system 10 may include a compressor 12, a combustor 14, and a turbine 16. The compressor 12 and turbine 16 may be coupled by a shaft 18. The shaft 18 may be a single shaft or a plurality of shaft segments coupled together to form shaft 18. The compressor 12 compresses an incoming flow of air 20 and deliver the compressed flow of air 22 to the combustor 14. The combustor 14 mixes the compressed flow of air 22 with a pressurized flow of fuel 24 and ignites the mixture to create a flow of combustion gases 26. The flow of combustion gases 26 includes hot gases, and may also be referred to as a hot gas flow; these terms are used interchangeably throughout the specification. In some embodiments, the turbine system 10 may include a plurality of combustors 14. The flow of combustion gases 26 is delivered to the turbine 16. The flow of combustion gases 26 drives the turbine to produce mechanical work. The mechanical work produced in the turbine 16 drives the compressor 12 via the shaft 18 and an external load 30 such as an electrical generator.

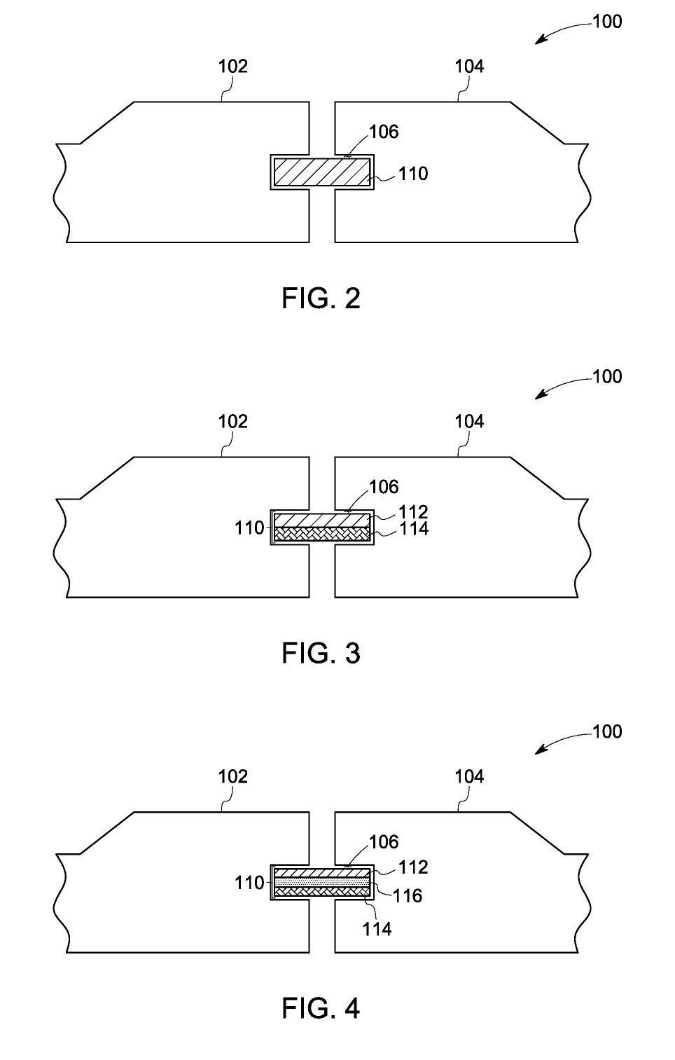

FIGS. 2-4 show a portion 100 of the turbine system 10 as described herein. In FIGS. 2-4, the turbine system 10 includes a first component 102 and a second component 104. The first component 102 and the second component 104 are arranged adjacent to one another in the turbine system 10. The first component 102 and the adjacent second component 104 may be at least a part of the turbine bucket assemblies, turbine nozzle assemblies, turbine shroud assemblies, transition pieces, stage one turbine nozzles, retaining rings, or compressor exhaust components. In some embodiments, the first component 102 and the second components 104 may be similar components, for example shroud segments of a turbine shroud assembly. In some embodiments, the first component 102 and the second components 104 may be different components or parts of different components. For example, the first component 102 may be a transition piece and the adjacent second component 104 may be a stage one turbine nozzle. Further, the first components 102 and the adjacent second component 104 of the present disclosure are not limited to the above components, but may be any components that are at least partially exposed to the hot gas flow, or any components that are subjected to multiple hot gas flows that have a substantial temperature gradient with respect to one another.

Referring to FIGS. 2-4, when the first component 102 and the second component 104 are arranged or joined adjacent to each other in the turbine system, the first component 102 and the second component 104 define a gap 106 between them. A sealing component 110 is positioned in the gap 106 between the first component 102 and the second component 104. The sealing component 110 blocks the gap 106 between the first and the second components (102, 104) to prevent a leakage of a hot gas flow, a cooling medium flow or both, or mixing of the two thereof. In some embodiments, the sealing component 110 may also be referred to as “spline seal.” In some embodiments, the sealing component 110 includes a ceramic material.

Ceramic materials generally have excellent hardness, heat resistance, abrasion resistance, and corrosion resistance, and are therefore desirable for high temperature applications such as gas turbines. However, ceramic materials typically exhibit grain growth as the temperature increases, and may shatter, crack or crumble under applied stress, strain or both because of poor ductility, lower density and a higher degree of brittleness than metals.

Some embodiments of the present disclosure provide the sealing component 110 that includes a ceramic material having fine-grains (or fine-grained ceramic material). In some embodiments, the sealing component 110 includes a ceramic material having grains of an average grain size of less than 10 microns. In some embodiments, the ceramic material has an average grain size less than 5 microns. In some embodiments, the ceramic material has an average grain size in a range from about 0.1 micron to about 5 microns. In some embodiments, the ceramic material includes grains having an average grain size in a range from about 0.2 microns to about 4 microns. In some embodiments, the average grain size of the ceramic material is in a range from about 0.5 micron to about 3 microns. In some embodiments, the average grain size of the ceramic material is in a range from about 0.5 micron to about 2 microns. In certain embodiments, the average grain size is in a range from about 1 micron to about 2 microns.

These fine-grained ceramic materials generally exhibit “superplasticity” or “superplastic deformation” at high temperatures, and may be referred to as superplastic ceramics. As used herein, the term “superplasticity” or “superplastic deformation” may refer to a state in which a solid crystalline material is deformed well beyond its usual breaking point, usually over about 200 percent during tensile deformation. These fine-grained ceramic materials may provide desired mechanical properties such as toughness, strength and strain-to-failure value at high temperatures. Such fine-grained ceramic materials may be desirable for enabling the desired characteristic for a sealing component in a turbine system such as creep resistance, shear/torsional strength and thermal shock resistance at high temperatures (for example, higher than 1200 degrees Celsius).

As used herein, the term “strain-to-failure” measures an amount of strain withstood by a solid material in tension before it fails or cracks.

The ceramic material may include a variety of materials. The ceramic material may be a first or a second ceramic material. In some embodiments, the ceramic material is a first ceramic material. The first ceramic material may be a ceramic composite having a base ceramic material and an additive. Examples of the base ceramic material include, but are not limited to, magnesium oxide, zirconia, hafnia, tantalum oxide, alumina, silicon nitride or combinations thereof. A fine dispersion of the additive in the base ceramic material pins the grain boundaries, thus inhibits grain growth and maintains the fine grain distribution as the temperature increases. The incorporation of the additive to the base ceramic material may improve the mechanical properties of the resulting ceramic composite, for example provide an improved strain-to-failure value (for example, higher than 0.1 percent) of a sealing component during a thermal shock. Examples of such additives include, but are not limited to, magnesium oxide, zirconia, hafnia, tantalum oxide, cupric oxide (CuO), rare earth oxides such as yttria and lanthana or combinations thereof.

In some embodiments, the first ceramic material includes a material selected from the group consisting of partially or fully stabilized zirconia, partially or fully stabilized hafnia, titania, doped alumina, toughened alumina, magnesium aluminate spinel, rare earth aluminate garnets or combinations thereof. Suitable examples of the first ceramic material include, but are not limited to, yttria stabilized zirconia (YSZ), CuO doped YSZ, alumina platelets doped zirconia or YSZ, unstabilized or partially stabilized zirconia toughened alumina, unstabilized or partially stabilized hafnia toughened alumina, zirconia-titania-hafnia or combinations thereof.

In certain embodiments, the first ceramic material includes nontransformable tetragonal partially or fully stabilized zirconia, nontransformable tetragonal partially or fully stabilized hafnia or combinations thereof. The nontransformable tetragonal partially or fully stabilized zirconia and the nontransformable tetragonal partially or fully stabilized hafnia refer to partially or fully stabilized zirconia and hafnia, respectively, in their nontransformable tetragonal phases. These nontransformable tetragonal phases of partially or fully stabilized zirconia and partially or fully stabilized hafnia generally have desirable strength, thermal and environmental stability and are able to retain the mechanical integrity at high temperatures and during the thermal cycling operations of turbine systems. Various processes can be used for the formation of nontransformable tetragonal phases of the partially or fully stabilized zirconia and partially or fully stabilized hafnia, for example quench forming from melt, laser melt quenching, plasma spraying, and e-beam physical vapor deposition. As an example, a powder of a suitable nontransformable tetragonal phase of yttria stabilized zirconia can be deposited onto a substrate by air plasma spraying to form a closed pore ceramic layer of a desired thickness. The formed layer can be stripped off the substrate and finished to a suitably required thickness for use as a sealing component as described herein. Another example may include forming a layer of yttria stabilized zirconia in the nontransformable tetragonal phase by fabricating from a melt phase.

In some other embodiments, the ceramic material is a second ceramic material having a low coefficient of thermal expansion (CTE) that may be referred to as a low-CTE ceramic material. In one embodiment, the second ceramic material has a coefficient of thermal expansion (CTE) less than 5×10⁻⁶ per degree Celsius. In some embodiments, the second ceramic material includes a material selected from the group consisting of silicates, disilicates, mullite, titanates, cordierite, phosphates, tantalates, niobates or combinations thereof. Suitable examples of the second ceramic materials include, but are not limited to, hafnium silicate, aluminum titanate, rare earth silicates or disilicates, modified sodium zirconium phosphate (NZP), alkaline earth or rare earth niobates, alkaline earth or rare earth tantalates such as TiTa₂O₇ or combinations thereof. Examples of suitable niobates include AlNb₉O₂₄, AlNb₁₁O₂₉, ZrNb₁₄O₃₇, GaNb₁₁O₂₉, TiNb2O₇, Ti₂Nb₁₀O₂₉, NiNb₁₄O₃₆, GeNb₁₈O₄₇, LaNb₅O₁₄, Ta₂O₅—Nb₂O₅ or combinations thereof.

Referring to Figures. 2-4 again, the sealing component 110 may be in form of a layer that extends to a length of a joining interface of the first component and the second component. As used herein, the term “layer” refers to a long rigid piece or bar of a material. Further, the term “layer” does not necessarily mean a uniform thickness, and the layer may have a uniform or a variable thickness. In some embodiments, the layer has a comparatively less thickness as compared to a length and a width of the layer.

In some embodiments as illustrated in FIG. 2, the sealing component 110 is a monolith layer. As used herein, the term “monolith layer” refers to a single layer composed of a ceramic material. The monolith layer may include a first ceramic material or a second ceramic material as described herein.

In some embodiments, the sealing component 110 includes a plurality of layers including same or different ceramic materials (that is a first ceramic material or a second ceramic material as described herein). In one embodiment as shown in FIG. 3, a sealing component 110 includes a bilayer structure having a first layer 112 and a second layer 114. The first layer 112 includes the first ceramic material and the second layer 114 includes the second ceramic material. The first layer 112 and the second layer 114 may be bonded with each other using any joining technique known in art for the ceramic joining such as cosintering and hot pressing.

FIG. 4, in some embodiment, illustrates a sealing component 110 including a bonding layer 116 disposed between the first layer 112 and the second layer 114. The first layer 112 and the second layer 116 are joined to each other using the bonding layer 116. In some embodiments, the first and second layers (112, 114) include a first ceramic material or a second ceramic material as described herein. The bonding layer 116 may include a bonding material for example a ceramic and a glass. The bonding layer 116 may be suitably porous or dense such that the bonding layer 116 deflects cracks formed in at least one of the first layer 112 or the second layer 114 during the operation. In one example, the first and second layers (112, 114) are composed of toughened alumina and the bonding layer 116 is composed of porous alumina interspersed and sintered to controlled porosity. Alternate example of the bonding material may be a suitable glass or a ceramic-glass formulation that can cohesively bond to the adjacent first and second layers (112, 114) and can yield by softening at operating temperatures. Also contemplated within the scope of embodiments presented herein are embodiments wherein the first layer and the second layer may include same or different ceramic materials (for example, a first ceramic material or the second ceramic material as described herein). Further, the sealing component 110 may include any number of layers, each layer having a first ceramic material or a second ceramic material as described herein.

In the sealing component having a plurality of layers, for example the bilayer and sandwich structures discussed above, a layer having a second ceramic material (i.e., a low-CTE ceramic material) may provide toughness and strength, and another layer including a first ceramic material (i.e., a composite ceramic) may provide desired flexibility and a high strain-to-failure capability to the sealing component 110.

In one embodiment, the sealing component 110 may sustain plastic deformation under a tension at a strain rate, for example in a range of from about 10⁻³ s⁻¹ to about 1 s⁻¹. In some embodiments, the sealing component 110 has a strain-to-failure value higher than 0.1 percent. In some embodiments, the strain-to-failure value of the sealing component 110 is in a range from about 0.1 percent to about 0.5 percent. In some embodiments, the strain-to-failure value of the sealing component 110 is in a range from about 0.1 percent to about 0.4 percent. In some embodiments, the strain-to-failure value of the sealing component 110 is in a range from about 0.1 percent to about 0.3 percent. In some embodiments, the strain-to-failure value of the sealing component 110 is in a range from about 0.2 percent to about 0.4 percent. In some embodiments, the sealing component 110 has a strength in a range from about 200 megapascals (MPa) to about 700 Mpa at room temperature. In some embodiments, the sealing component 110 has a strength in a range from about 200 MPa to about 400 Mpa at room temperature. In some embodiments, the sealing component 110 has a strength in a range from about 500 MPa to about 700 Mpa at room temperature.

The sealing component 110, that is the monolith layer or the plurality layers of the sealing component of the present disclosure, may have any shape known in the art. For example, in one embodiment, the sealing component 110 may have rectangular cross-sections, as shown in FIGS. 2-4. Further, in some other embodiments, the sealing component 110 may have any cross-sectional shapes known in the art that may provide a seal between adjacent components 100 of a turbine system. Further, the sealing component 110 may have a substantially flat profile, a substantially U-shaped profile, a substantially S-shaped profile, a substantially W-shaped profile, or a substantially N-shaped profile.

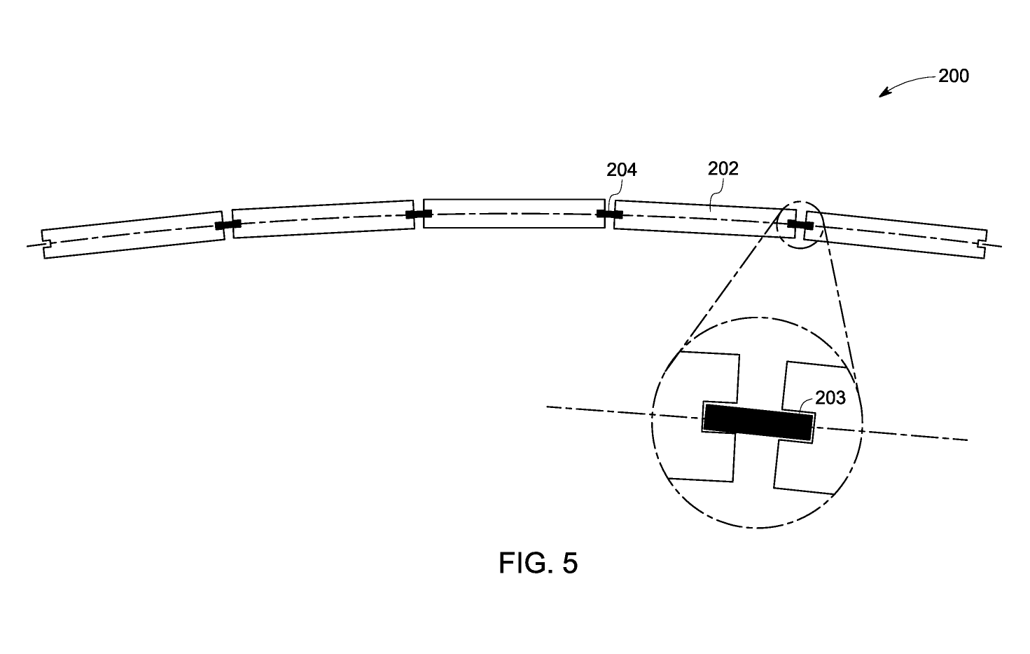

In one embodiment, FIG. 5 shows a cross sectional view of a portion of a turbine shroud assembly 200. The turbine shroud assembly 200 may include a plurality of shroud segments 202. The shroud segments 202 are arranged adjacent to one another to form an annular structure. In one embodiment, the shroud segments 202 include a ceramic matrix composite (CMC). A particular example of a CMC material is a material having a matrix of silicon carbide or silicon nitride, with a reinforcement phase of silicon carbide disposed within the matrix, often in the form of fibers. The turbine shroud assembly 200 may further include a sealing component 204 disposed between two adjacent shroud segment 202. In some embodiments, the sealing component 204 may be disposed in a slot or a channel 203 defined on adjacent shroud segments 202. In some embodiments, the turbine shroud assembly 200 includes a plurality of sealing components 202 disposed between each pair of the shroud segments 202.

### EXAMPLES

Two ceramic sealing materials were produced by casting fine-grained (grain size approximately 1 micron) yttria stabilized zirconia (YSZ) and silicon nitride, separately in ceramic molds. The samples were cut from the cast ceramic sealing materials into bars with desired length and thickness of a turbine seal.

### Flow Bench Testing

The sample ceramic bars were installed in a flow rig. A pressure differential ranging from 20 psi to 120 psi was applied across the sample ceramic bars by flowing air through a path which consisted of a sample ceramic bar placed over a gap which was similar in dimension to a gap between adjacent shroud segments in a gas turbine. The performance of the sample ceramic bars was similar to that of conventional metallic seals. Further, it was observed that the sample ceramic bars were able to withstand the strain generated in the unsupported portions of the sample ceramic bars due to the applied pressure differential.

### Strength Test—Modulus of Rupture (MOR) Test

The sample ceramic bars were tested for Modulus of Rupture (MOR) test. A 3-point bend test using a 4″ span length was performed on these sample ceramic bars at temperature conditions of about 70 degrees Fahrenheit and about 2000 degrees Fahrenheit. The sample ceramic bars were loaded at a rate of 0.05 inch/min until catastrophic failure occurred. The maximum load (or stress) and elastic modulus were recorded for all sample ceramic bars. MOR tests at room temperature and at 2000 degrees Fahrenheit resulted in maximum strengths ranging from about 200 MPa to about 700 MPa. The strain-to-failure values of these sample ceramic bars were in a range from about 0.1 percent to about 0.4 percent.

### Thermal Shock Test

The sample ceramic bars were loaded into a rapid cycle furnace for the thermal shock test. Sample ceramic bars were heated to about 2070 degrees Fahrenheit in about 15 minutes and then held at this temperature for about 5 hours. After this heat treatment, sample ceramic bars were immediately air quenched to room temperature with the assistance of fan blowing air and then held at room temperature for about 10 minutes. This thermal cycle was repeated about 100 times and then the sample ceramic bars were examined visually after the final cycle. All of the sample ceramic bars survived the rapid furnace cycle test and were considered to be in good condition upon the completion of the thermal shock test.

### Engine Test

The sample ceramic bars were installed in a rig which simulated a combustion environment. The sample ceramic bars were able to withstand thermal and mechanical loading at about 1500 degrees Fahrenheit and about 20 psi for about 12 hours.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. A turbine system comprising:
a sealing component comprising a ceramic material, wherein the ceramic material comprises grains having an average grain size of less than 10 microns.

2. The turbine system of claim 1, wherein the average grain size is less than 5 microns.

3. The turbine system of claim 1, wherein the average grain size is in a range of from about 0.1 micron to about 5 microns.

4. The turbine system of claim 1, wherein the ceramic material comprises a material selected from the group consisting of partially or fully stabilized zirconia, partially stabilized hafnia, doped alumina, toughened alumina, titania, magnesium aluminate spinel, rare earth aluminate garnets or combinations thereof.

5. The turbine system of claim 1, wherein the ceramic material comprises a nontransformable tetragonal partially or fully stabilized zirconia, nontransformable tetragonal partially or fully stabilized hafnia and combinations thereof.

6. The turbine system of claim 1, wherein the ceramic material has a coefficient of thermal expansion less than 5×10⁻⁶ per degree Celsius.

7. The turbine system of claim 6, wherein the ceramic material comprises a material selected from the group consisting of silicates, disilicates, mullite, titanates, cordierite, phosphates, tantalates, niobates or combinations thereof.

8. The turbine system of claim 1, wherein the sealing component comprises a monolith layer.

9. The turbine system of claim 1, wherein the sealing component comprises a plurality of layers.

10. The turbine system of claim 1, comprising a turbine shroud assembly, wherein the sealing component is disposed in the turbine shroud assembly.

11. A turbine shroud assembly, comprising:
a plurality of shroud segments disposed adjacent to one another; and
a sealing component positioned between two adjacent shroud segments of the plurality of shroud segments, wherein the sealing component comprises a ceramic material comprising grains having an average grain size of less than 10 microns.

12. The turbine shroud assembly of claim 11, wherein the plurality of shroud segments comprises a ceramic matrix composite.
